(19) United States
(12) Patent Application Publication
(10) Pub. No.: US 2021/0373717 A1
(43) Pub. Date: Dec. 2, 2021

(54) CONSUMER APPLIANCE USER INTERFACES AND METHODS FOR FADING ILLUMINATED ICONS

(71) Applicant: Haier US Appliance Solutions, Inc., Wilmington, DE (US)

(72) Inventors: Christopher Lane McClure, Louisville, KY (US); Timothy Ray Jackson, Louisville, KY (US); Steven Keith Root, Buckner, KY (US)

(21) Appl. No.: 16/886,918

(22) Filed: May 29, 2020

(51) Int. Cl. G06F 3/0482

(52) U.S. Cl. CPC G06F 3/0482

(57) ABSTRACT

A user interface for a consumer appliance, including a method for operating the same, may provide for directing illumination of a first menu icon of the plurality of discrete menu icons at an operational brightness level, and receiving a selection signal corresponding to a second menu icon of the plurality of discrete menu icons during directing illumination of the first menu icon. The second menu icon may be in a relatively-dim state during directing illumination of the first menu icon. Furthermore, the user interface or method may provide for transmitting, based on the second-icon selection signal, an immediate illumination signal directing increased illumination of the second menu icon; and directing, based on the second-icon selection signal, a gradual brightness reduction of the first menu icon from the operational brightness level.

### FIELD OF THE INVENTION

The present subject matter relates generally to user interfaces for consumer appliances, such as refrigerator appliances, and methods for fading the illumination of one or more icons of the user interface.

### BACKGROUND OF THE INVENTION

Consumer appliances, such as refrigerators, ovens, microwaves, dishwashers, etc., often utilize one or more icons (i.e., predefined text, graphics, symbols, etc.) provided with a control panel or user interface. In particular, certain icons may be selectively illuminated or deactivated (i.e., to stop illumination of the icon) to guide a user through one or more menu options. For instance, by illuminating one or more icons, the user interface may indicate what functions or settings may be selected by a user at a given moment. Moreover, by selectively illuminating/deactivating various icons, the user interface may provide a concise menu with access to a large number of applicable functions/settings without requiring all icons to be illuminated simultaneously, which may be visually cluttered, confusing, or otherwise unattractive.

In spite of these advantages, existing appliance user interfaces have a number disadvantages that can arise, especially when changing between one portion of the menu and another. For instance, the menu can be changed such that some icons are illuminated and other icons are deactivated. If these icons are both illuminated and deactivated immediately, though, it can be difficult for a user to discern exactly which icons have been changed or deactivated. Moreover, the overall impression can be that the user interface is cheap or of poor quality. Gradually increasing the brightness of certain icons and gradually decreasing the brightness of other icons may be attempted to address these concerns, but this can frustrate users by creating the impression that the user interface is slow or unresponsive.

As a result, it would be useful to provide a consumer appliance or user interface addressing one or more of the above issues. In particular, it may be advantageous to provide a user interface or method of operating the same that is perceived as both responsive and easily-understood by users.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a method of operating a user interface of a consumer appliance is provided. The method may include directing illumination of a first menu icon of the plurality of discrete menu icons at an operational brightness level, and receiving a selection signal corresponding to a second menu icon of the plurality of discrete menu icons during directing illumination of the first menu icon. The second menu icon may be in a relatively-dim state during directing illumination of the first menu icon. The method may further include transmitting, based on the second-icon selection signal, an immediate illumination signal directing increased illumination of the second menu icon; and directing, based on the second-icon selection signal, a gradual brightness reduction of the first menu icon from the operational brightness level.

In another exemplary aspect of the present disclosure, an appliance user interface panel is provided. The appliance user interface panel may include an external panel, a first light source, a second light source, and a controller. The external panel may define a first light passage according to a first menu icon and a second light passage according to a second menu icon. The first light source may be mounted behind the external panel and directed to the first light passage. The second light source may be mounted behind the external panel and directed to the second light passage. The controller may be operably coupled to the first light source and the second light source. The controller may be configured to initiate a display operation. The display operation may include directing illumination of the first menu icon at an operational brightness level, and receiving a selection signal corresponding to a second menu icon during directing illumination of the first menu icon. The second menu icon may be in a relatively-dim state during directing illumination of the first menu icon. The display operation may further include transmitting, based on the second-icon selection signal, an immediate illumination signal directing increased illumination of the second menu icon; and directing, based on the second-icon selection signal, a gradual brightness reduction of the first menu icon from the operational brightness level.

In yet another exemplary aspect of the present disclosure, a refrigerator appliance is provided. The refrigerator appliance may include a cabinet, a door rotatably attached to the cabinet, a user interface mounted to the door, and a controller. The user interface may include an external panel, a first light source, and a second light source. The external panel may define a first light passage according to a first menu icon and a second light passage according to a second menu icon. The first light source may be mounted behind the external panel and directed to the first light passage. The second light source may be mounted behind the external panel and directed to the second light passage. The controller may be operably coupled to the first light source and the second light source. The controller may be configured to initiate a display operation. The display operation may include directing illumination of the first menu icon at an operational brightness level, and receiving a selection signal corresponding to a second menu icon during directing illumination of the first menu icon. The second menu icon may be in a relatively-dim state during directing illumination of the first menu icon. The display operation may further include transmitting, based on the second-icon selection signal, an immediate illumination signal directing increased illumination of the second menu icon; and directing, based on the second-icon selection signal, a gradual brightness reduction of the first menu icon from the operational brightness level.

In another exemplary aspect of the present disclosure, an appliance user interface panel is provided. The appliance user interface panel may include an external panel, a first light source, a second light source, and a controller. The external panel may define a first light passage according to a first menu icon and a second light passage according to a second menu icon. The first light source may be mounted behind the external panel and directed to the first light passage. The second light source may be mounted behind the external panel and directed to the second light passage. The controller may be operably coupled to the first light source and the second light source. The controller may be configured to initiate a display operation. The display operation may include directing illumination of the first menu icon at an operational brightness level, and receiving a selection signal corresponding to a second menu icon during directing illumination of the first menu icon. The second menu icon may be in a relatively-dim state during directing illumination of the first menu icon. The display operation may further include transmitting, based on the second-icon selection signal, an immediate illumination signal directing increased illumination of the second menu icon; and directing, based on the second-icon selection signal, a gradual brightness reduction of the first menu icon from the operational brightness level.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a consumer appliance according to exemplary embodiments of the present disclosure.

FIG. 2 provides a simplified sectional view of a portion of the user interface of a consumer appliance according to exemplary embodiments of the present disclosure.

FIG. 3 provides a plan view of a portion of a user interface of a consumer appliance according to exemplary embodiments of the present disclosure, wherein each menu icon of a plurality of menu icons is illustrated for clarity.

FIG. 4 provides a plan view of the exemplary user interface of FIG. 3, wherein the menu icons of one menu branch set are illuminated.

FIG. 5 provides a plan view of the exemplary user interface of FIG. 3, wherein the menu icons of another menu branch set are illuminated.

FIG. 6 provides a plan view of the exemplary user interface of FIG. 3, wherein the menu icons of yet another menu branch set are illuminated.

FIG. 7 provides a plan view of the exemplary user interface of FIG. 3, wherein the menu icons of still another menu branch set are illuminated.

FIG. 8 provides a plan view of the exemplary user interface of FIG. 3, wherein the menu icons of a further menu branch set are illuminated.

FIG. 9 provides a flow chart illustrating a method of operating a user interface of a consumer appliance according to exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components.

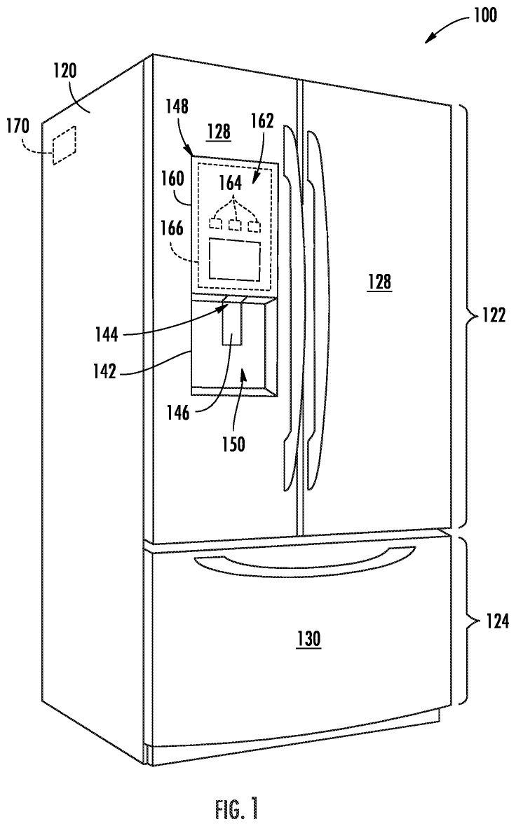

Turning now to the figures, FIG. 1 illustrates a consumer appliance 100 according to exemplary embodiments of the present disclosure. Generally, consumer appliance 100 includes a cabinet 120 on which one or more communications features (e.g., a control panel 160) are mounted. In the exemplary embodiments of FIG. 1, consumer appliance is provided as a refrigerator appliance 100. However, as would be understood, consumer appliance 100 may be provided as any suitable consumer appliance (e.g., a microwave, oven, cooktop, range, dishwasher, washing machine, dryer, etc.), except as otherwise indicated.

As generally illustrated in FIG. 1, refrigerator appliance 100 includes a housing or cabinet 120 that defines chilled chambers for receipt of food items for storage. In particular, cabinet 120 defines a fresh food chamber 122 positioned at or adjacent the top of cabinet 120 and a freezer chamber 124 arranged at or adjacent the bottom of cabinet 120. As such, refrigerator appliance 100 is generally referred to as a bottom mount refrigerator. It is recognized, however, any other suitable appliance or refrigerator style, such as, for example, a top mount refrigerator appliance, a side-by-side style refrigerator appliance, etc. may be provided. Consequently, the description set forth herein is for illustrative purposes only and is not intended to be limiting in any aspect to any particular refrigerator chamber configuration or, as noted above, any particular style of appliance.

Refrigerator doors 128 are rotatably hinged to an edge of cabinet 120 for selectively accessing fresh food chamber 122. In addition, a freezer door 130 is arranged below refrigerator doors 128 for selectively accessing freezer chamber 124. Freezer door 130 is attached to a freezer drawer (not shown) slidably mounted within freezer chamber 124. Refrigerator doors 128 and freezer door 130 are shown in the closed configuration in FIG. 1.

In some embodiments, refrigerator appliance 100 also includes a dispensing assembly for dispensing liquid water or ice. The dispensing assembly includes a dispenser 142 positioned on or mounted to an exterior portion of refrigerator appliance 100 (e.g., on one of refrigerator doors 128). Dispenser 142 includes a discharging outlet 144 for accessing ice and liquid water. An actuating mechanism 146, shown as a paddle, is mounted below discharging outlet 144 for operating dispenser 142. In alternative exemplary embodiments, any suitable actuating mechanism may be used to operate dispenser 142. For example, dispenser 142 can include a sensor (such as an ultrasonic sensor) or a button rather than the paddle.

Discharging outlet 144 and actuating mechanism 146 are an external part of dispenser 142 and are mounted in a dispenser recess 150. Dispenser recess 150 is positioned at a predetermined elevation convenient for a user to access ice or water and enabling the user to access ice without the need to bend-over and without the need to open refrigerator doors 128.

As shown, a user interface 148 having a control panel 160 is provided for user engagement (e.g., input or output) with refrigerator appliance 100. For example, user interface 148 may generally provide for controlling the mode of operation or communicating information about appliance operation. Any suitable type of user input 164 (e.g., buttons, switches, touchscreens, etc.) may be provided on control panel 160 to initiate or direct operation of the refrigerator appliance 100. As will be described in greater detail below, one or more of the inputs 164 may be provided a predefined menu icon (e.g., touch input). In some such embodiments, a contact surface 162 is defined by a touch panel 166 (e.g., capacitance or resistance touch panel) overlaid across at least a portion of control panel 160. During use, a user may thus engage, select, or adjust various inputs 164 on control panel 160 through contact with the same.

Operation of the refrigerator appliance 100 can be generally controlled or regulated by a controller 170. In some embodiments, controller 170 is operably coupled to user interface panel 148 and various other components, as will be described below. User interface panel 148 provides selections for user manipulation of the operation of refrigerator appliance 100. As an example, user interface panel 148 may provide for selections between whole or crushed ice, chilled water, or specific modes of operation. In response to one or more input signals (e.g., from user manipulation of user interface panel 148 or one or more signals received from a connected sensor), controller 170 may operate various components of the refrigerator appliance 100 according to the current mode of operation.

Controller 170 may include a memory and one or more microprocessors, CPUs or the like, such as general or special purpose microprocessors operable to execute programming instructions or micro-control code associated with operation of refrigerator appliance 100. The memory may represent random access memory such as DRAM, or read only memory such as ROM or FLASH. In some embodiments, the processor executes programming instructions stored in memory. For certain embodiments, the instructions include a software package configured to operate appliance 100. The memory may be a separate component from the processor or may be included onboard within the processor. Alternatively, controller 170 may be constructed without using a microprocessor (e.g., using a combination of discrete analog or digital logic circuitry; such as switches, amplifiers, integrators, comparators, flip-flops, AND gates, and the like) to perform control functionality instead of relying upon software.

Controller 170, or portions thereof, may be positioned in a variety of locations throughout refrigerator appliance 100. In exemplary embodiments, controller 170 is located on or behind the user interface panel 148 (e.g., within refrigerator door 128). In other embodiments, the controller 170 may be positioned at any suitable location within refrigerator appliance 100, such as within the fresh food chamber 122, a freezer door 130, etc. Input/output (“I/O”) signals may be routed between controller 170 and various operational components of refrigerator appliance 100. For example, user interface panel 148 may be operably coupled to controller 170 via one or more signal lines or shared communication busses.

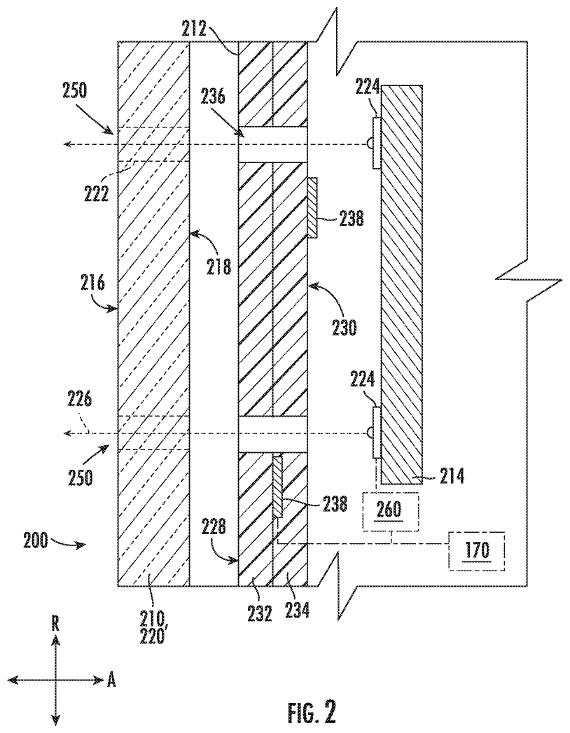

Turning now to FIG. 2, a sectional view is provided of a portion of a user interface 200 (e.g., provided as or as part of control panel 160—FIG. 1) according to exemplary embodiments of the present disclosure. As shown, user interface 200 generally defines an axial direction A extending from a front end of user interface 200 to a back end of a user interface 200. For example, the front end may be disposed at the touch surface 162 (FIG. 1) of appliance 100 (e.g., to receive a user's touch or input) while the back end is disposed within the door 128 or cabinet 120 (e.g., and is generally inaccessible to a user during operation of appliance 100). In addition to the axial direction A, user interface 200 generally defines a radial direction R perpendicular to the axial direction A.

In optional embodiments, user interface 200 includes multiple layers or panels. For instance, an external panel 210 (e.g., as or as part of control panel 160—FIG. 1), a sensor board 212, and a light board 214 may be stacked together along the axial direction A. As would be understood, one or more mechanical fasteners (e.g., bolts, nuts, brackets, etc.), adhesives, solders, or combinations thereof may join the stacked layers together or otherwise hold the same in a fixed position relative to each other. As shown, at least a portion of external panel 210, sensor board 212, and light board 214 may each be aligned with each other along the axial direction A and radial direction R. When assembled, sensor board 212 and light board 214 are provided in communication (e.g., electrical or wireless communication) with or as part of controller 170.

As shown, external panel 210 includes an outer surface 216. When assembled, outer surface 216 faces outward in order for a user to engage or contact external panel 210 at outer surface 216. Outer surface 216 can define an exterior or outermost surface of the user interface 200 along the axial direction A. Opposite from the outer surface 216 (e.g., relative to the axial direction A), external panel 210 includes an inner surface 218. For instance, inner surface 218 may face or otherwise be directed toward an inner volume of a door or cabinet of an appliance.

In certain embodiments, at least a portion of external panel 210 is formed from one or more suitable dielectric and solid or nonpermeable material, such as a plastic material (e.g., acrylic, polycarbonate, etc.) or ceramic material (e.g., glass or glass-ceramic). In optional embodiments, the external panel 210 includes a light permissive (e.g., transparent or translucent) pane 220. The light permissive pane 220 may define a light passage 222. The light passage 222 may be a solid passage of nonpermeable material or, alternatively, a void to permit one or more light emissions 226 from a light source 224 mounted behind external panel 210. Thus, at least a portion of light emissions 226 that are directed from the light source 224 may be transmitted through light passage 222 (e.g., into the ambient area in front of the user interface 200). When assembled, light passage 222 may be defined at a corresponding menu icon 250 such that the menu icon 250 can be selectively illuminated (e.g., according to user engagement with one or more inputs 164—FIG. 1).

Behind the external panel 210, a sensor board 212 may be mounted, as shown. In some embodiments, sensor board 212 provides a printed circuit board (“PCB”) onto which one or more electrical components and electrical circuit paths may be provided. When assembled, a forward surface 228 of sensor board 212 may face forward toward the external panel 210. A rearward surface 230 of sensor board 212 (e.g., opposite from the forward surface 228 relative to the axial direction A) may face away from the external panel 210. For instance, the rearward surface 230 may be directed toward the light board 214.

Optionally, multiple stacked boards 232, 234 (e.g., multiple single-sided PCBs) may be held together between the forward surface 228 and the rearward surface 230 (e.g., by a suitable fastener, adhesive, etc.). Alternatively, sensor board 212 may be provided a single-sided PCB defining both forward surface 228 and rearward surface 230.

Between the forward surface 228 and the rearward surface 230, the sensor board 212 may define a light aperture 236. For instance, light aperture 236 may be axially aligned with the light passage 222 such that light emissions 226 may be directed through the sensor board 212 and to the external panel 210.

On the sensor board 212, one or more touch sensors 238 may be mounted. Thus, the touch sensor 238 is supported on a portion the sensor board 212. Each touch sensor 238 may be provided as any suitable sensor for detecting an electrical field generated by a user's body (e.g., through a rigid dielectric panel). For instance, the touch sensor 238 may be a capacitive sensor to detect variation in capacitance, as would be understood. When assembled, a touch sensor 238 may be mounted at or adjacent to a corresponding menu icon, such that user engagement or touch may select the corresponding menu icon 250. Such engagement may be detected at touch sensor 238 and transmitted to controller 170 (e.g., as a selection signal) to indicate a user intends to select the setting or feature corresponding to the menu icon 250. Additionally or alternatively, activation or acceptance from a particular touch sensor 238 may correspond to illumination of the corresponding menu icon 250 (e.g., such that touch inputs from a user will not be detected unless the corresponding menu icon 250 is also illuminated).

Separate from or in addition to the touch sensor(s) 238, one or more light sources 224 are mounted on a light board 214. For instance, a light source 224 may be mounted at (e.g., supported on) a light board 214 behind external panel 210 or sensor board 212. In some such embodiments, at light source 224 may be spaced apart from a corresponding light aperture 236 (e.g., axially spaced apart along the axial direction A). Generally, light source 224 may be directed at light passage 222 or light aperture 236 (e.g., axially aligned therewith) to direct light emissions 226 through the same, such as to illuminate a corresponding menu icon. Thus, each menu icon may be provided with a corresponding light source.

Light source 224 may be provided as any suitable electrical light source 224, such as a light-emitting diode (LED), fluorescent bulb, halogen bulb, etc. Activation or illumination of light source 224 may be generally controlled by controller 170 (FIG. 1), such as according to one or more active menu branches or option sets (e.g., to indicate a user input, state of the appliance, settings of the appliance, or any other relevant information to a user).

It is noted that although FIG. 2 illustrates sensor board 212 as being axially spaced apart from and behind external panel 210, alternative embodiments may provide sensor board 212 in contact with the inner surface 218 or, alternatively, on the outer surface 216 of the external panel 210.

It is also noted that further alternative embodiments may provide any suitable backlit display having multiple predetermined menu icons, as would be understood. For instance, a light source and touch sensor may be mounted on a common printed control board behind an external panel or lens. Optionally, an opaque light guide may be axially disposed between each light source and the external panel. Such opaque light guide(s) define one or more guide openings to direct light emissions from the light source(s) to one or more corresponding icons defined on the external panel. Additionally or alternatively, a coating or film may be applied to external panel to further define one or more of the icons.

Turning now generally to FIGS. 3 through 8, various views are provided of a user interface 200, including a control panel 240 (e.g., provided as or part of control panel 160—FIG. 1), having multiple selectively-illuminated or disappearing menu icons 250. Although various particular icons are shown as specific words or signals, the present disclosure is generally applicable to any arrangement or format of text/symbols that can be defined.

Generally, user interface 200 provides a plurality of discrete menu icons 250. Each of the menu icons 250 may include a corresponding light source 224 (FIG. 2) (i.e., one or more light sources). For instance, one or more light passages 222 (FIG. 2) may be defined (e.g., according to a particular word or symbol) in front of a corresponding light source 224, as described above.

Turning especially to FIG. 3, the user interface 200 may provide a physically-fixed number and type of menu icons 250 that can thus not be expanded after assembly. In turn, each menu icon 250 can selectively illuminate at a predefined region of control panel 240. One or more of the discrete menu icons 250 may be spaced apart from each other (e.g., radially). FIG. 3 shows each of the potential menu icons 250 of an exemplary embodiment for the sake of clarity. Nonetheless, during use, it is only the menu icons 250 that are active (i.e., active icons 254, which are illuminated by a corresponding light source 224—FIG. 2) at a given moment that will be visible to a user. When a particular menu icon 250 is deactivated or otherwise unilluminated, the corresponding predefined region (e.g., text, graphic, or symbol) may appear as a blank or solid region, as would be understood.

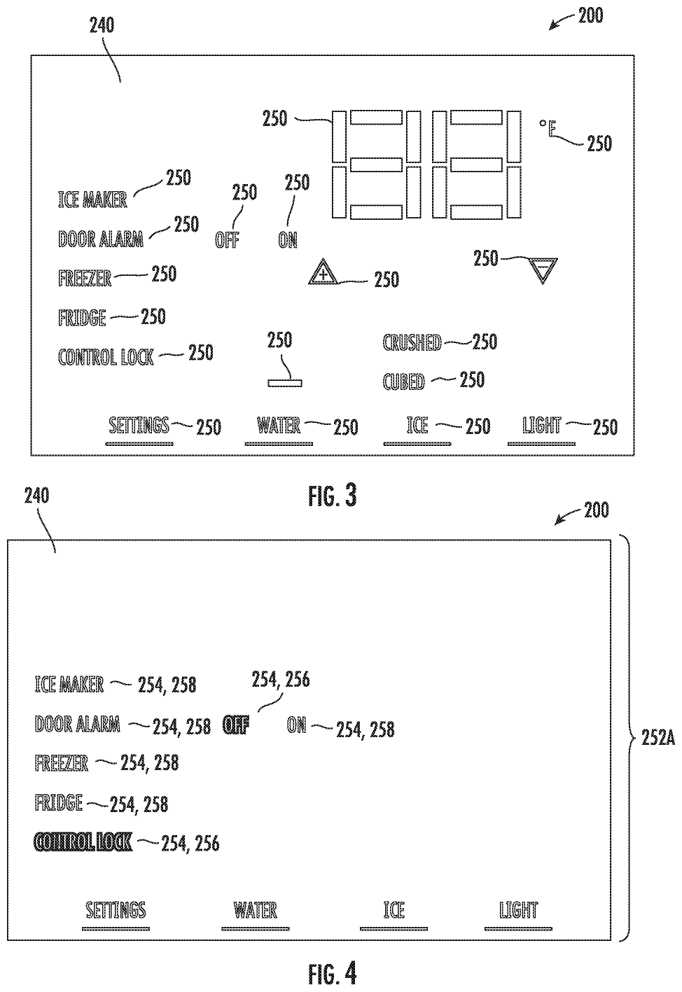

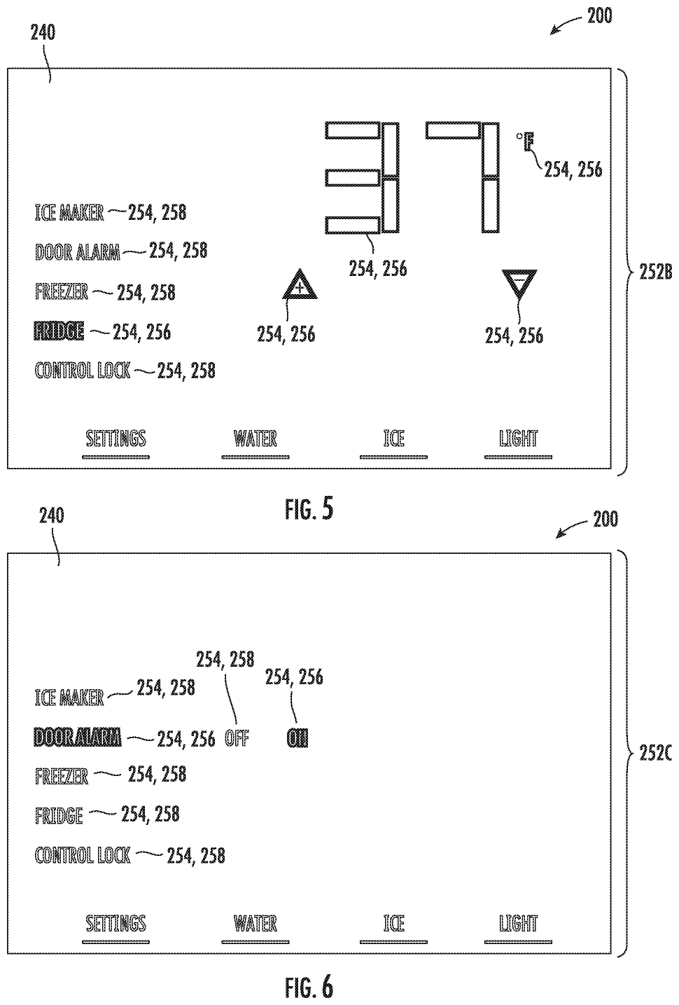

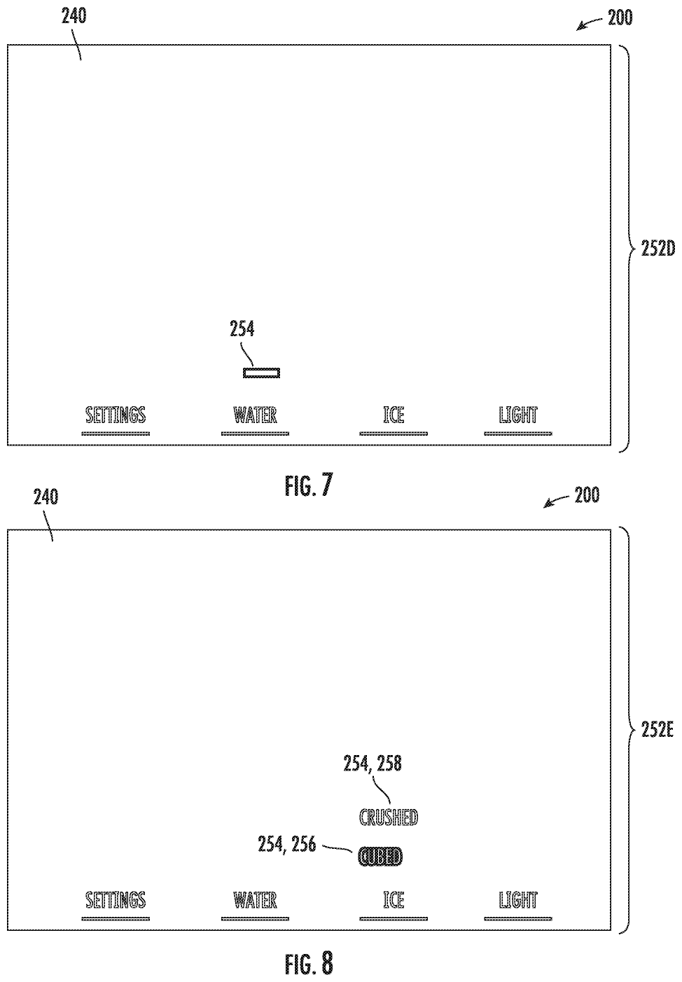

Since it may be visually confusing or cluttered to illuminate each menu icon 250 at the same time, separate or discrete menu branches (i.e., menu branch sets) 252A, 252B, 252C, 252D, 252E may be provided (e.g., according to a program provided on controller 170—FIG. 1) such that only certain appliance features or options can be viewed or selected by a user at a given moment. FIGS. 4 through 8 each illustrate different menu branch sets of the same exemplary user interface 200. Specifically, FIG. 4 illustrates a first menu branch 252A, FIG. 5 illustrates a second menu branch 252B, FIG. 6 illustrates a third menu branch 252C, FIG. 7 illustrates a fourth menu branch 252D, and FIG. 8 illustrates a fifth menu branch 252E. As shown, each menu branch 252A, 252B, 252C, 252D, 252E has one or more active icons 254 that can be simultaneously illuminated. During use, only the active icons 254 of the discrete menu icons 250 may thus be visible or selectable (e.g., by a user's touch adjacent to a corresponding touch sensor 238—FIG. 2). All of the other (e.g., inactive) icons of the discrete menu icon 250 will not be illuminated, visible, or otherwise selectable. Optionally, one or more menu icons 250 may be constantly-active icons maintaining the same active brightness level across multiple menu branches 252A, 252B, 252C, 252D, 252E—such as the case of “SETTINGS,” “WATER,” “ICE,” and “LIGHT” in the embodiments of FIGS. 3 through 8.

Generally, the brightness level (e.g., luminance, intensity, average power, etc.) of the active icons 254 may be set in advance. Specifically, each active icon 254 may have one or more operational brightness levels (i.e., greater than 0 or an unilluminated level). As an example, certain active icons 254 may have a relatively high or featured brightness level and a relatively low or muted brightness level. Such active icons 254 may switch or alternate between featured and muted brightness levels while a corresponding menu branch 252A, 252B, 252C, 252D, or 252E is displayed (e.g., depending on which corresponding menu branch 252A, 252B, 252C, 252D, or 252E is displayed). Thus, one or more of the corresponding menu branches 252A, 252B, 252C, 252D, 252E may have at least one featured icon 256 and one or more muted icons 258. As would be understood, featured icons 256 may, for instance, illustrate a feature or setting that is “live” or otherwise subject to adjustment (e.g., as directed by a user's engagement) at a given moment. Muted icons 258 may, for instance, illustrate other features or settings of the corresponding given branch that may be selected or changed, but are not selected or otherwise subject to adjustment at the given moment. Thus, the particular featured and muted icons 258 of the discrete menu icons 250 for a given menu branch 252A, 252B, 252C, 252D, 252E may be changed or alternated according to user input or engagement.

In some embodiments, a featured icon 256 maintains a constant operational brightness level (e.g., featured brightness level). In additional or alternative embodiments, a muted icon 258 maintains a constant brightness level (e.g., muted brightness level) that is less than the brightness level of the featured icons 256. Thus, while a given discrete menu icon 250 is the featured icon 256, it will appear brighter than the muted icons(s) 258.

The brightness level of the light sources 224 (FIG. 2) of the menu icons 250 may be dictated or varied according to any suitable method. In exemplary embodiments, for instance, a constant supply voltage is directed to the active icon(s) 254 (e.g., from the controller 170). Operational brightness levels may be varied (e.g., between the featured and the muted brightness levels) by varying a duty cycle or pulse-width modulation (PWM) of the constant voltage. As would be understood, the duty cycle may pulse the supply voltage according to a programmed refresh rate, temporarily halting illumination of light source and corresponding active icon 254. Thus, varying the duty cycle may effectively vary the voltage at the corresponding active icon 254.

Generally, the refresh rate of the duty cycle is rapid enough that temporarily halting illumination is not directly visible to a user as a break in illumination. Instead, multiple temporary halts in illumination are perceived as a reduction in brightness. For instance, the refresh rate may be faster than a 50 millisecond period (e.g., less than or equal to a 40 millisecond period, less than or equal to a 30 millisecond period, etc.). In some such embodiments, reducing or decreasing brightness of an active icon 254 is accomplished by decreasing the PWM percentage (i.e., increasing the amount of time within each period for which illuminating is temporarily halted). For instance, a new brightness-level signal may be received to decrease the PWM percentage. Thus, decreasing a brightness level may include reducing a PWM of power (e.g., by reducing the PWM voltage supply) to a light source of the first menu icon 250. As an example, at a 100% PWM, the constant supply voltage to an active icon 254 may be steady and uninterrupted (e.g., such that illumination to the active icon 254 is not temporarily halted). In response to a decreased brightness-level signal, the constant supply voltage to the active icon 254 may be interrupted accordingly (e.g., such that illumination to the active icon 254 is temporarily halted). In the case of a 50% PWM, the constant supply voltage to the active icon 254 is interrupted for half of each period (e.g., such that half of the periods provide illumination of the active icon 254). Additionally or alternatively, variations in brightness between multiple discrete active icons 254 (e.g., a featured icon 256 and a muted icon 258) may be established by discrete PWM percentages at such active icons 254. For instance, a featured icon 256 may have a relatively-large first PWM percentage (e.g., 100%) while a muted icon 258 may have a relatively-small second PWM percentage (e.g., 50%).

During use, the brightness of one or more active icons 254 is selectively varied. Specifically, the brightness of such active icons 254 may be varied disproportionately such that increases in brightness are directed differently than decreases in brightness. For instance, changing the menu branches 252A, 252B, 252C, 252D, 252E of user interface 200 (e.g., from one menu branch 252A, 252B, 252C, 252D, or 252E to another of the menu branches 252A, 252B, 252C, 252D, or 252E) may provide for illuminating the new or selected menu branch 252A, 252B, 252C, 252D, or 252E at a faster rate than the dimming of the current or previously-selected menu branch 252A, 252B, 252C, 252D, or 252E. In a specific example, changing from the first menu branch 252A to the second menu branch 252B may provide for illuminating the second menu branch 252B immediately and, thus, at a faster rate than the dimming of the first menu branch 252A

In some embodiments, the increase in brightness for one or more (e.g., all or alternatively, less than all) of the discrete menu icons 250, such as when such menu icons 250 are illuminated from an inactive state or a muted active state, is immediate. In other words, an increasing change in brightness may be instant and may correspond to a single signal (e.g., from controller 170). Moreover, there may be no delay (e.g., at controller 170) for directing the (e.g., constant) supply voltage to the corresponding active icon 254 according to a PWM percentage of the operational brightness level. Thus, a menu icon 250 may immediately illuminate in an active state at its full operational brightness level (e.g., predetermined brightness level corresponding to the corresponding menu branch, selected inputs, general brightness settings of control panel 240, etc.). For instance, if a featured icon 256 is being illuminated (e.g., from an inactive or muted state), the PWM percentage of the featured state may be immediately provided to the featured icon 256. Additionally or alternatively, if a muted icon 258 is being illuminated (e.g., from an inactive state), the PWM percentage of the muted state may be immediately provided to the muted icon 258.

In additional or alternative embodiments, the reduction in brightness for one or more of the discrete menu icons 250, such as when such menu icons 250 are dimmed from an active state to an inactive state or when such icons are dimmed from a featured active state to a muted active state, is gradual. Thus, the brightness of a particular discrete menu icon 250 may be faded. In other words, a reduction or decreasing change in brightness may be gradual.

The decreasing change may be effectuated by any suitable signal or predetermined scheme. For instance, the decreasing change may be effectuated by a single instruction signal (e.g., when voltage decays naturally, such as through a capacitor 260 as described below) or, alternatively, a plurality of discrete instruction signals (e.g., when reduction in brightness is provided through a sequential decrease in the PWM percentage of a constant supply voltage). Thus, a menu icon 250 may dim from its full operational brightness level in a manner that is both gradual and visually perceptible to the human eye. As an example, if a featured icon 256 is being dimmed to a muted state, the PWM percentage may be decreased over a set period of time or at a set rate (e.g., linear rate) until the muted state is reached. A user may thus perceive brightness levels that are between the operational brightness level of the featured state and the muted state. Additionally or alternatively, if a muted icon 258 is being dimmed to an inactive state, the PWM percentage may be decreased over a set period of time or at a set rate (e.g., linear rate) until the corresponding icon is off (i.e., no longer emitting light therefrom). A user may thus perceive brightness levels that are between the operational brightness level of the muted state and the unilluminated state.

Fading of a specific menu icon 250 may be context driven (e.g., according to the specific menu branch 252A, 252B, 252C, 252D, 252E in which the specific menu icon 250 lies, according to the setting or feature to which the specific menu icon 250 indicates, etc.). Thus, a reducing brightness change for certain menu icons 250 may be programmed to be different from other menu icons 250. For instance, although some menu icons 250 may be programmed to fade as described above, such as when one menu branch (e.g., 252B) is being dimmed following selection of a new menu branch (e.g., 252A, 252C, 252D, or 252E), other menu icons 250 or entire menu branches 252A, 252B, 252C, 252D, or 252E may be programmed to dim or reduce in brightness immediately (e.g., when transitioning from an active state to an inactive state, when transitioning from a featured active state to a muted active state, etc.). As an example, a temperature menu icon 250, such as that illustrated in FIG. 5 may be programmed to dim immediately from an active state, while one or more of the rest of the menu icons 250 of the menu branch 252B of FIG. 5 may be programmed to dim from the active operational brightness level gradually.

Advantageously, changes regarding which icons 250 are illuminated be easily and quickly perceived by a user (e.g., without causing frustration or impressions of sluggishness).

Returning briefly to FIG. 2, in optional embodiments, a capacitor 260 is electrically connected (e.g., in series) between the controller 170 and the light source 224 of a corresponding discrete menu icon 250. Specifically, capacitor 260 may be provided along the same electrical path through which a supply voltage is transmitted to the corresponding light source 224 (e.g., from controller 170). As would be understood, the capacitor 260 may temporarily hold or store electrical energy therein. Thus, the capacitor 260 may store energy from the supply voltage. In some such embodiments, once transmission of the supply voltage to the corresponding light source 224 is stopped, the capacitor 260 may release a stored voltage (e.g., at a predetermined decay rate). As the stored voltage is released and decays at the light source 224, the illumination of the light source and corresponding menu icon 250 decays accordingly.

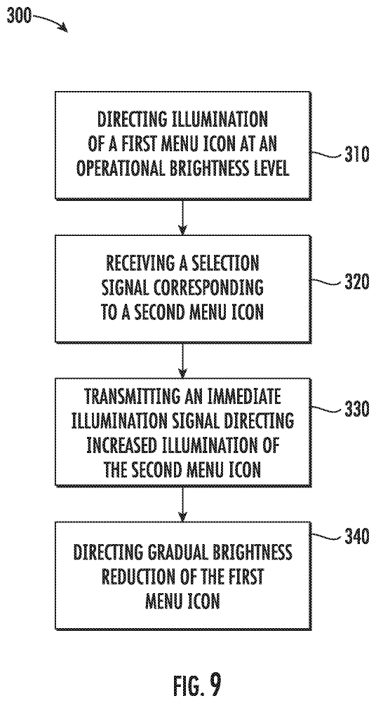

Turning now to FIG. 9, various methods may be provided for use with a consumer appliance (e.g., appliance 100) in accordance with the present disclosure. In general, the various steps of methods as disclosed herein may, in exemplary embodiments, be performed by the controller 170 part of a display operation that the controller 170 is configured to initiate. During such methods, controller 170 may receive inputs and transmit outputs from various other components of the appliance 100. For example, controller 170 may send signals to and receive signals from user interface 200, including light source(s) 224 and input(s) 166. In particular, the present disclosure is further directed to methods, as indicated by 300, for operating appliance 100. Such methods advantageously perceived as both responsive and easily-understood by users.

At 310, the method 300 includes directing illumination of a first menu icon at an operational brightness level. The operational brightness level may be constant (e.g., for the duration of 310 or while the first menu icon is in an active state). Thus, 310 generally requires maintaining the light source of the first menu icon in an active state wherein light is emitted from the light source and the brightness of the first menu icon does not perceptibly (e.g., visibly) change as it is viewed by a user. For instance, a constant supply voltage may be transmitted to the first menu icon according to a duty cycle having a programmed refresh rate and PWM percentage corresponding to the operational brightness level. Optionally, the operational brightness level may be a featured brightness level or a muted brightness level. During 310, other discrete menu icons, such as a second or third menu icon, may be maintained in a relatively-dim state, such as an inactive state (i.e., unilluminated) or, alternatively, in a muted state. Additionally or alternatively, input signals may be received (e.g., via one or more user inputs of the user interface) corresponding to the first menu icon.

At 320, the method 300 includes receiving a selection signal corresponding to a second menu icon (e.g., during a portion of or immediately following 310). The second menu icon may be provided in the same menu branch as the first menu icon or, alternatively, in a separate menu branch. Thus, the selection signal received at 320 may correspond to a different feature or setting within the same menu branch as the first menu icon or, alternatively, to a different menu branch of the user interface. The selection signal may be received in response to user engagement with an input (e.g., touch sensor) the user interface. Moreover, the selection signal received at 320 may generally indicate a user's desire to focus on a different feature or setting than that of the first menu icon. In some embodiments, the second menu icon is unilluminated prior to or during 320 (i.e., such that no light emissions are being generated at and projected from the light source of the second menu icon).

At 330, the method 300 includes transmitting an immediate illumination signal directing increased illumination of the second menu icon. Specifically, the transmission of the immediate illumination signal may be based on (e.g., prompted by or otherwise in response to) receiving the second-icon selection signal at 320. For instance, upon receiving the second-icon selection signal, the brightness of the second icon may be increased from an inactive or unilluminated brightness level to the full operational brightness level. Thus, a user may perceive the activation of the second menu icon as being instantaneous (e.g., after selecting a new menu branch that corresponds to the second menu icon).

At 340, the method 300 includes directing gradual brightness reduction of the first menu icon. Specifically, the gradual brightness reduction may be based on (e.g., prompted by or otherwise in response to) receiving the second-icon selection signal at 320. Optionally, 340 may overlap or occur simultaneously with the increased illumination of the second menu icon at 330. Alternatively, 340 may follow or occur immediately after (e.g., in direct response to) completion of 330. As the brightness is reduced, it may be set to 0 (i.e., an inactive or unilluminated brightness level) such that no voltage is received at the first menu icon and no light is emitted therefrom (e.g., such that the first menu icon appears to disappear or be turned off). In certain embodiments, the reduction of the brightness level is linear (e.g., from the operational brightness level at 310 to 0). Thus, the fading or dimming of the first menu icon may appear to occur at a constant (e.g., predetermined, programmed) rate, advantageously preventing the impression of sluggishness or error.

In some embodiments, 340 includes transmitting a plurality of sequentially-decreasing brightness-level signals to the first menu icon. For instance, 3 or more sequentially-decreasing brightness-level signals may be transmitted at a set rate (e.g., a 99% PWM signal, a 66% PWM signal, and a 33% PWM signal transmitted at sequential 30 millisecond intervals). Thus, the brightness level of the first menu icon may be sequentially-decreased. As described above, each sequential brightness-level signal may decrease the PWM percentage. Thus, 340 may include reducing a PWM of power to a light source of the first menu icon.

Following the plurality of sequentially-decreasing brightness-level signals, the brightness level of the first menu icon may be set to 0 (i.e., an inactive or unilluminated brightness level) such that no voltage is received at the first menu icon and no light is emitted therefrom (e.g., such that the first menu icon appears to disappear or be turned off). The reduction from the operational brightness level at 310 to 0 may be set to occur over a preset fade timespan less than or equal to a maximum value (e.g., 5 seconds, 2 seconds, 1 second, 0.5 seconds), but greater than or equal to a minimum value (e.g., 0.05 seconds, 0.1 seconds, 0.2 seconds). For instance, the reduction from 310 to 0 may be set to a preset fade timespan less than or equal to 2 seconds and greater than or equal to 0.05 seconds, although any other exemplary maximum/minimum may be considered within the scope of the present disclosure.

Optionally, the number of sequentially-decreasing brightness-level signals may be set as a predetermined interval value greater than 3 (e.g., 5, 10, 15, 20). Thus, the first menu icon may be reduced by more than three steps or intervals prior to be set to an inactive or unilluminated brightness level. Additionally or alternatively, the number of sequentially-decreasing brightness-level signals may be set according to a linear reduction rate (e.g., based on the refresh rate of the light source of the menu icon). In turn, the reduction of a featured menu icon to 0 may take more time than the reduction of a muted menu icon.

In certain embodiments, directing the gradual brightness reduction includes reducing voltage at the first menu icon. For instance, the voltage may be reduced according to sequential steps or signals, as described above. Alternatively, the voltage may be decayed naturally. As an example, a transmitted supply voltage to the first menu icon may be temporarily stored, then decreased at a decaying rate from the capacitor once the controller issues a signal to halt transmission of the supply voltage. Thus, 340 may include decaying a transmitted voltage through a capacitor in electrical communication with a light source of the first menu icon.

In some embodiments, the same gradual brightness reduction occurs for multiple further menu icons. Additionally or alternatively, one or more icons may have a distinct brightness reduction. For instance, the method 300 may provide for immediate brightness reduction of another (e.g., third) menu icon. In some such embodiments, the method 300 further includes directing illumination of the second menu icon at an operational brightness level (e.g., constant operational brightness level) following 340. For instance, the second menu icon may optional be a temperature setting display, as described above. The method 300 may still further include receiving a third icon selection signal corresponding to a third menu icon of the plurality of discrete menu icons during directing illumination of the second menu icon. The third menu icon may be unilluminated during directing illumination of the second menu icon. The method 300 may yet further include transmitting an immediate illumination signal directing increased illumination of the third menu icon (e.g., based on or in response to receiving) the third-icon selection signal). Moreover, the method 300 may include directing an immediate brightness reduction of the second menu icon from the operational brightness level of the second menu icon (e.g., based on the third-icon selection signal).

Still further illumination/dimming of further menu icons would be understood in light of the present disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of operating a user interface of a consumer appliance, the user interface comprising a plurality of discrete menu icons each having a corresponding light source, the method comprising:
directing illumination of a first menu icon of the plurality of discrete menu icons at an operational brightness level;
receiving a selection signal corresponding to a second menu icon of the plurality of discrete menu icons during directing the illumination of the first menu icon, the second menu icon being in a relatively-dim state during directing the illumination of the first menu icon;
transmitting, based on the second-icon selection signal, an immediate illumination signal directing increased illumination of the second menu icon; and
directing, based on the second-icon selection signal, a gradual brightness reduction of the first menu icon from the operational brightness level, the gradual brightness reduction being gradual relative to time to reduce the illumination of the first menu icon over a preset fade timespan,
wherein the gradual brightness reduction is directed at a linear rate of reduction of voltage or a plurality of sequentially-decreasing brightness level signals from the operational brightness level to an unilluminated brightness level.

2. The method of claim 1, wherein directing the gradual brightness reduction comprises transmitting the plurality of sequentially-decreasing brightness-level signals to the first menu icon.

3. The method of claim 1, wherein directing the gradual brightness reduction comprises reducing the voltage at the first menu icon.

4. The method of claim 3, wherein reducing the voltage comprises decaying a transmitted voltage through a capacitor in electrical communication with a light source of the first menu icon.

5. The method of claim 3, wherein the voltage to the first menu icon is reduced at the linear rate from the operational brightness level to the unilluminated brightness level.

6. (canceled)

7. The method of claim 1, wherein the gradual brightness reduction comprises reducing brightness at the first icon from the operational brightness level to the unilluminated brightness level over the preset fade timespan, the preset fade timespan being less than or equal to two seconds.

8. The method of claim 7, wherein the preset fade timespan is greater than or equal to 0.05 seconds.

9. The method of claim 1, wherein directing the gradual brightness reduction comprises reducing a pulse-width modulation of power to a light source of the first menu icon at the linear rate.

10. The method of claim 1, further comprising:
directing the illumination of the second menu icon at a second operational brightness level following transmitting the immediate illumination signal;
receiving a third icon selection signal corresponding to a third menu icon of the plurality of discrete menu icons during directing the illumination of the second menu icon, the third menu icon being in a relatively-dim state during directing the illumination of the second menu icon;
transmitting, based on the third-icon selection signal, an immediate illumination signal directing increased illumination of the third menu icon; and
directing, based on the third-icon selection signal, an immediate brightness reduction of the second menu icon from the second operational brightness level of the second menu icon.

11. An appliance user interface panel comprising:
an external panel defining a first light passage according to a first menu icon and a second light passage according to a second menu icon;
a first light source mounted behind the external panel and directed to the first light passage;
a second light source mounted behind the external panel and directed to the second light passage; and
a controller operably coupled to the first light source and the second light source, the controller being configured to initiate a display operation, the display operation comprising
directing illumination of the first menu icon at an operational brightness level,
receiving a selection signal corresponding to a second menu icon during directing the illumination of the first menu icon, the second menu icon being in a relatively-dim state during directing the illumination of the first menu icon,
transmitting, based on the second-icon selection signal, an immediate illumination signal directing increased illumination of the second menu icon, and
directing, based on the second-icon selection signal, a gradual brightness reduction of the first menu icon from the operational brightness level, the gradual brightness reduction being gradual relative to time to reduce the illumination of the first menu icon over a preset fade timespan,
wherein the gradual brightness reduction is directed at a linear rate of reduction of voltage or a plurality of sequentially-decreasing brightness level signals from the operational brightness level to an unilluminated brightness level.

12. The appliance user interface panel of claim 11, wherein directing the gradual brightness reduction comprises transmitting the plurality of sequentially-decreasing brightness-level signals to the first menu icon.

13. The appliance user interface panel of claim 11, wherein directing the gradual brightness reduction comprises reducing the voltage at the first menu icon.

14. The appliance user interface panel of claim 13, wherein reducing the voltage comprises decaying a transmitted voltage through a capacitor in electrical communication with the first light source of the first menu icon.

15. The appliance user interface panel of claim 13, wherein the voltage to the first menu icon is reduced at the linear rate from the operational brightness level to the unilluminated brightness level.

16. (canceled)

17. The appliance user interface panel of claim 11, wherein the gradual brightness reduction comprises reducing brightness at the first icon from the operational brightness level to the unilluminated brightness level over the preset fade timespan, the preset fade timespan being less than or equal to two seconds.

18. The appliance user interface panel of claim 17, wherein the preset fade timespan is greater than or equal to 0.05 seconds.

19. The appliance user interface panel of claim 11, wherein directing the gradual brightness reduction comprises reducing a pulse-width modulation of power to the first light source of the first menu icon at the linear rate.

20. A refrigerator appliance comprising:
a cabinet;
a door rotatably attached to the cabinet;
a user interface mounted to the door, the user interface comprising
an external panel defining a first light passage according to a first menu icon and a second light passage according to a second menu icon,
a first light source mounted behind the external panel and directed to the first light passage, and
a second light source mounted behind the external panel and directed to the second light passage; and
a controller operably coupled to the first light source and the second light source, the controller being configured to initiate a display operation, the display operation comprising
directing illumination of the first menu icon at an operational brightness level,
receiving a selection signal corresponding to a second menu icon during directing the illumination of the first menu icon, the second menu icon being in a relatively-dim state during directing the illumination of the first menu icon,
transmitting, based on the second-icon selection signal, an immediate illumination signal directing increased illumination of the second menu icon, and
directing, based on the second-icon selection signal, a gradual brightness reduction of the first menu icon from the operational brightness level, the gradual brightness reduction being gradual relative to time to reduce the illumination of the first menu icon over a preset fade timespan,
wherein the gradual brightness reduction is directed at a linear rate of reduction of voltage or a plurality of sequentially-decreasing brightness level signals from the operational brightness level to an unilluminated brightness level.
